(19) United States
(12) Patent Application Publication
(10) Pub. No.: US 2022/0332466 A1
(43) Pub. Date: Oct. 20, 2022

(54) SHRINK LABEL AND METHOD OF USE

(71) Applicant: Fuji Seal International, Inc., Osaka (JP)

(72) Inventor: Billy Brady, Bardstown, KY (US)

(21) Appl. No.: 17/760,926

(22) PCT Filed: Sep. 24, 2020
(86) PCT No.: PCT/IB2020/000788

§ 371 Date: Mar. 16, 2022

Related U.S. Application Data
(60) Provisional application No. 62/906,897, filed on Sep. 27, 2019.

(51) Int. Cl. B65D 23/08; B65D 55/08; B65C 3/06

(52) U.S. Cl. CPC B65D 23/0878; B65D 55/0854; B65C 3/065

(57) ABSTRACT

A shrink label includes a first end surface, a second end surface, and a puncture extending along a portion of the shrink label between the first and second end surfaces such that the puncture is spaced a first distance away from the first end surface and the puncture is spaced a second distance away from the second end surface. The puncture is expandable to form an opening when the shrink label shrinks from an open state to a shrunk state.

### PRIORITY

This application claims priority to U.S. Provisional Application No. 62/906,897, entitled “Shrink Label For A Bottle,” filed on Sep. 27, 2019, the disclosure of which is incorporated by reference herein.

### TECHNICAL FIELD

The disclosed embodiments generally pertain to shrink labels.

### BACKGROUND

Containers, such as bottles, typically have a body that is configured to hold a product, such as a liquid, within an interior space of the body. The body may include an opening to dispense product through the opening and a cap selectively coupled with the body for covering the opening of the body. In some versions, the cap comprises a trigger and a nozzle to allow a user to squeeze the trigger to dispense the product within the container through the nozzle of the cap. In some other versions, the cap comprises a nozzle and a pump for dispensing the product within the container through the nozzle of the cap. A shrink label can be applied about a portion of the body and/or cap in order to display product names or the like, achieve decorative effects, and/or provide a tamper-proof covering. In some instances, the cap may loosen from the body during shipping or transportation of the container, which may allow product to leak from the container. It may therefore be desirable to provide a shrink label that is configured to inhibit leaking during shipping or transportation.

While a variety of shrink labels have been made and used, it is believed that no one prior to the inventors has made or used an invention as described herein.

### BRIEF DESCRIPTION OF THE DRAWINGS

It is believed the present invention will be better understood from the following description of certain examples taken in conjunction with the accompanying drawings, in which like reference numerals identify the same elements.

FIG. 1 depicts a side elevational view of a first exemplary shrink label applied to a container.

FIG. 2 depicts a perspective view of the shrink label of FIG. 1 applied to the container.

FIG. 3 depicts a side elevational view of the shrink label of FIG. 1 in an open configuration prior to shrinking.

FIG. 4 depicts a side elevational view of a second exemplary shrink label for application to a container in an open configuration prior to shrinking.

FIG. 5 depicts a perspective view of a third exemplary shrink label applied to a container.

FIG. 6 depicts a side elevational view of the shrink label of FIG. 5 for application to a container in an open configuration prior to shrinking.

FIG. 7 depicts a schematic of an apparatus for making a shrink label.

FIG. 8A depicts a schematic of the apparatus of FIG. 7, showing a tubular strip of material being fed onto the apparatus.

FIG. 8B depicts a schematic of the apparatus of FIG. 7, showing the tubular strip of material positioned on the apparatus.

FIG. 8C depicts a schematic of the apparatus of FIG. 7, showing the tubular strip of material being punctured by a blade to form a shrink label.

FIG. 8D depicts a schematic of the apparatus of FIG. 7, showing the blade being retracted from the shrink label.

FIG. 8E depicts a schematic of the apparatus of FIG. 7, showing the shrink label being advanced from the apparatus.

The drawings are not intended to be limiting in any way, and it is contemplated that various embodiments of the invention may be carried out in a variety of other ways, including those not necessarily depicted in the drawings. The accompanying drawings incorporated in and forming a part of the specification illustrate several aspects of the present invention, and together with the description serve to explain the principles of the invention; it being understood, however, that this invention is not limited to the precise arrangements shown.

### DETAILED DESCRIPTION

The following description of certain examples of the invention should not be used to limit the scope of the present invention. Other examples, features, aspects, embodiments, and advantages of the invention will become apparent to those skilled in the art from the following description, which is by way of illustration, one of the best modes contemplated for carrying out the invention. As will be realized, the invention is capable of other different and obvious aspects, all without departing from the invention. Accordingly, the drawings and descriptions should be regarded as illustrative in nature and not restrictive.

It is further understood that any one or more of the teachings, expressions, embodiments, examples, etc. described herein may be combined with any one or more of the other teachings, expressions, embodiments, examples, etc. that are described herein. The following-described teachings, expressions, embodiments, examples, etc. should therefore not be viewed in isolation relative to each other. Various suitable ways in which the teachings herein may be combined will be readily apparent to those of ordinary skill in the art in view of the teachings herein. Such modifications and variations are intended to be included within the scope of the claims.

For clarity of disclosure, spatial terms such as “lower,” “upper,” “below,” “above,” “top,” “bottom,” “vertical,” “vertically,” “downward,” “side,” “inside,” “interior,” and “exterior” are used herein for reference to relative positions and directions. Such terms are used below with reference to views as illustrated for clarity and are not intended to limit the innovation described herein.

The word “exemplary” is used herein to mean “serving as an example, instance, or illustration.” Any implementation described herein as “exemplary” is not necessarily to be construed as preferred or advantageous over other implementations.

In some instances, there is a desire for a shrink label that is configured to inhibit product from leaking from a container, such as between a bottle and a cap and/or from a nozzle, during shipping or transportation. Accordingly, a shrink label can be applied to a portion of the cap and/or a portion of the body of the container. The shrink label includes a puncture that is breakable and/or expandable during shrinking of the shrink label to form an opening configured to receive a protrusion of the container to allow the protrusion to extend through the opening of the shrink label when the shrink label is applied to the container. This may maintain the position of the cap relative to the body of the container and/or inhibit actuation of the container. In some versions, the shrink label includes a perforation line to aid in the removal of at least a portion of the shrink label from the container.

### I. EXEMPLARY SHRINK LABEL COMPRISING AN OPENING

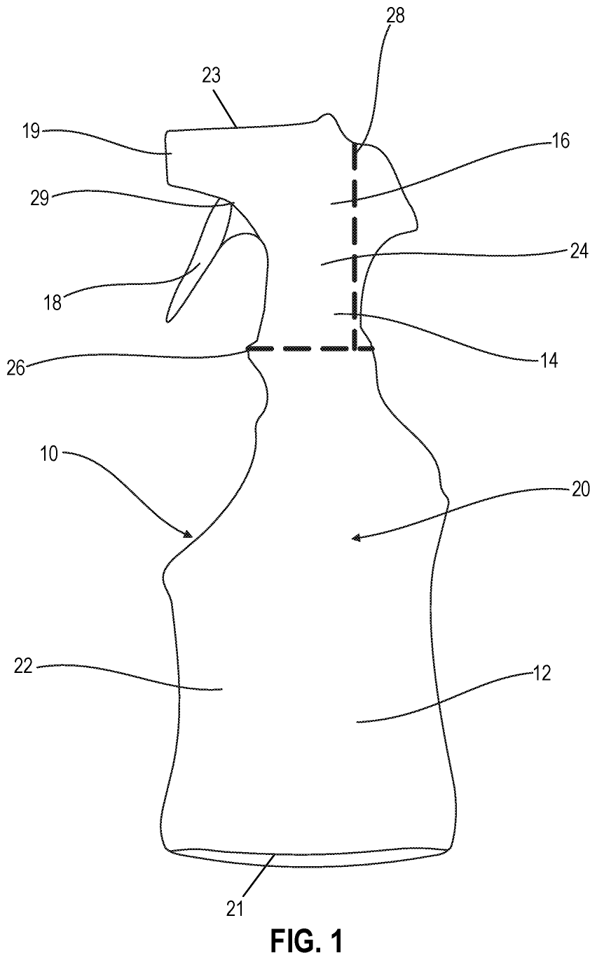

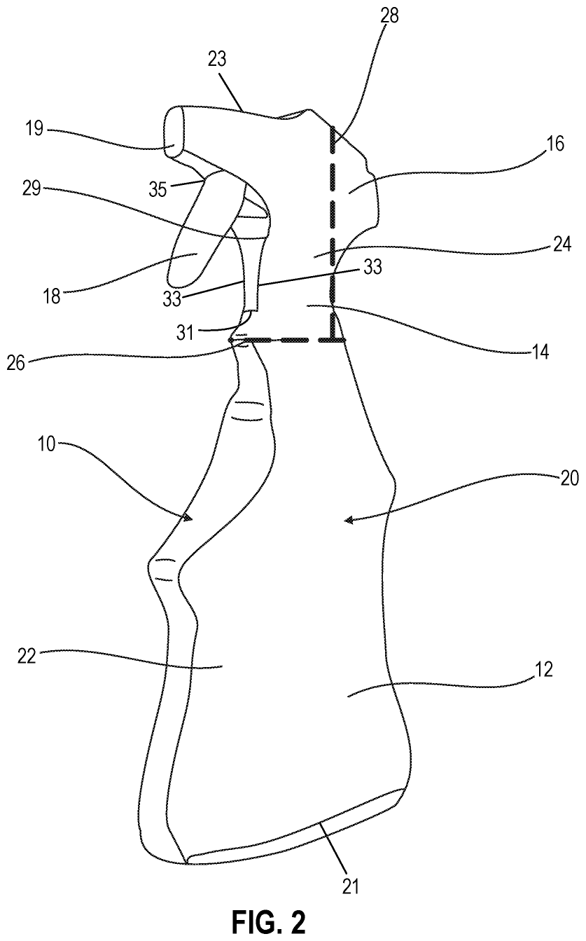

Referring to FIGS. 1 and 2, a first exemplary shrink label (20) is shown applied to a container (10) comprising a body (12) and a cap (16) couplable with body (12). In the illustrated version, body (12) is in the form of a bottle, though any other suitable container can be used (e.g., a jug, a carton, a can, a jar, etc.). As shown in FIG. 1, body (12) defines an interior space for storing product. A top end portion of body (12) includes a neck (14) having an opening (not shown) to provide access to the product within body (12). In the illustrated version, neck (14) is threadably coupled with cap (16). In some other versions, cap (16) may be coupled with body (12) using other suitable configurations, such as a snap fit, a friction fit, a living hinge, etc. Cap (16) in the illustrated version includes a protrusion, configured as a trigger (18), and a nozzle (19) such that a user may actuate trigger (18) to pivot trigger (18) inwardly towards body (12) to thereby dispense the product within body (12) through nozzle (19).

Shrink label (20) is shown positioned about container (10). Shrink label (20) comprises a tubular material having a bottom surface (21) and a top surface (23). Shrink label (20) can be made from any suitable plastic material that is configured to shrink and thereby form to container (10) when heated. As shown in FIGS. 1-3, shrink label (20) comprises a lower portion (22) and an upper portion (24) separated by a first perforation line (26). Lower portion (22) of shrink label (20) thereby extends below first perforation line (26) to a bottom surface (21) of shrink label (20) to cover at least a portion of body (12) of container (10). In the illustrated version, lower portion (22) extends to a bottom portion of a side of body (12) of container (10). In some other versions, lower portion (22) may extend farther onto a bottom surface of body (12) or lower portion (22) may extend less to cover only a portion of body (12). Upper portion (24) of shrink label (20) extends above first perforation line (26) to a top surface (23) of shrink label (20) to cover at least a portion of cap (16) of container (10). In the illustrated version, upper portion (24) extends to a top surface of cap (16) such that upper portion (24) is configured to enclose nozzle (19).

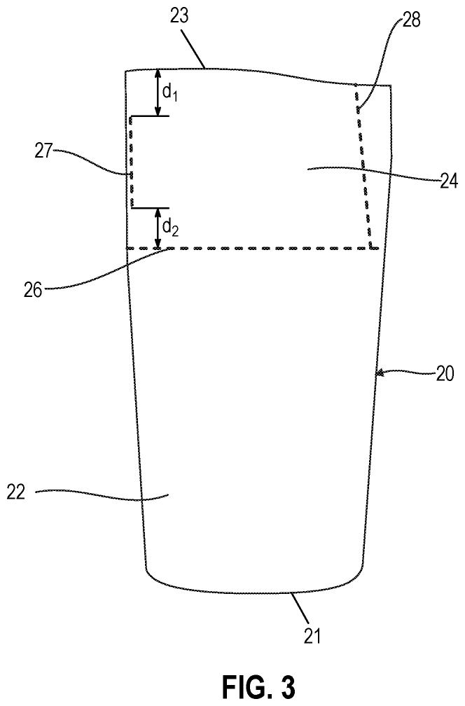

First perforation line (26) is positioned to extend circumferentially about shrink label (20) in a circumferential direction of the tubular material of shrink label (20). In the illustrated version, first perforation line is positioned slightly below neck (14) of body (12). In some other versions, first perforation line (26) may be positioned farther below neck (14), or at or above neck (14). In the illustrated version, first perforation line (26) also extends continuously about the entire circumference of shrink label (20). In some other versions, first perforation line (26) extends about only a portion of shrink label (20). Shrink label (10) further comprises one or more second perforation lines (28) extending transversely relative to first perforation line (26), through upper portion (24) of shrink label (20), from first perforation line (26) to top surface (23) of shrink label (20). As shown in FIG. 3, second perforation line (28) may be oriented obliquely relative to first perforation line (26) in an open configuration, prior to shrinking of shrink label (20), such that second perforation line (28) is oriented substantially vertically after shrink label (20) has been applied to bottle (10), as shown in FIGS. 1 and 2. Shrink label (20) is breakable along first and second perforation lines (26, 28) such that first and second perforation lines may help a user remove upper portion (24) and/or lower portion (22) of shrink label (20) prior to use of container (10). It should be noted that first and/or second perforation lines (26, 28) are optional.

Referring to FIGS. 1 and 2, shrink label (20) further comprises an opening (29) extending through upper portion (24) to allow a protrusion, such as trigger (18), of container (10) to be exposed through opening (29) when shrink label (20) is applied to container (10). Prior to shrinking, as shown in FIG. 3, shrink label (20) comprises a puncture that is configured to tear and/or expand during shrinking of shrink label (20) to form opening (29). In the illustrated version, the puncture is configured as a third perforation line (27) extending generally longitudinally along a portion of upper portion (24) transverse to first perforation line (26) and in an axial direction of the tubular material of shrink label (20), though any other suitable orientations of perforation line (27) can be used such that perforation line (27) is configured to tear and/or expand during shrinking of shrink label (20). For instance, the puncture of shrink label (20) may be formed as a perforation line, a slit, a laser cut, an opening, etc. Third perforation line (27) is formed such that third perforation line (27) is configured to tear more easily than first and second perforation lines (26, 28).

As shown in FIG. 3, third perforation line (27) extends along only a portion of upper portion (24) such that third perforation line (27) is positioned a first distance (d₁) above first perforation line (26) and a second distance (d₂) below a top surface (23) of shrink label (20). First and second distances (d₁, d₂) may be substantially equal in length, or first and second distances (d₁, d₂) may have different lengths such that one of the first or second distances (d₁, d₂) is greater than the other. The length of third perforation line (27) thereby generally corresponds to the length of trigger (18), but any other suitable lengths can be used, such as a length corresponding to any suitable protrusion of container (10). Still other suitable configurations for shrink label (20) will be apparent to one with ordinary skill in the art in view of the teachings herein.

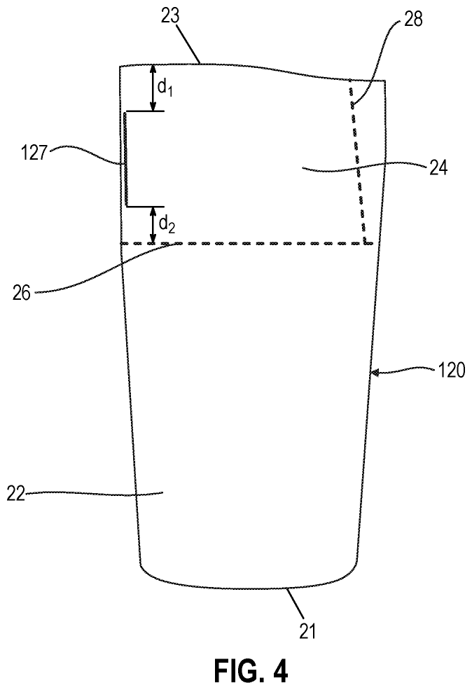

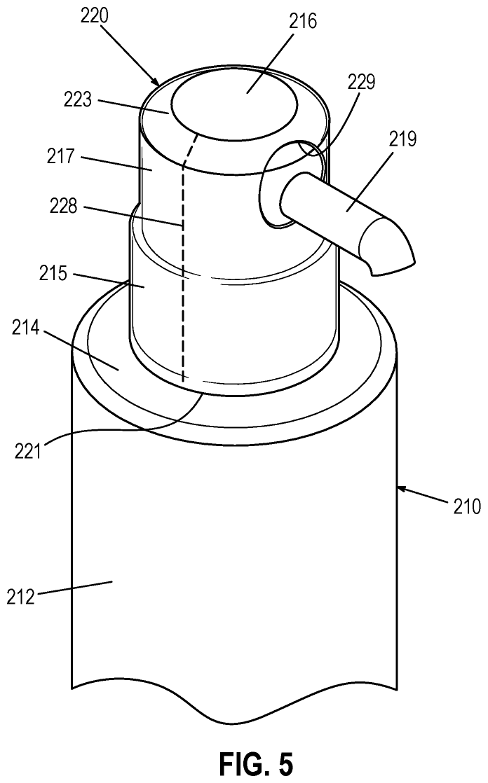

For instance, while one perforation line (27) is shown, any suitable number of perforation lines (27) may be formed to allow any suitable number of protrusions of container (10) to be exposed through such perforation lines (27). In some versions, one or more perforation lines (26, 27, 28) may be formed within lower portion (22). In some versions, one or more perforation lines (26, 27, 28) can be formed to correspond to an aesthetic design on container (10). Moreover, while the puncture in the illustrated version is shown as a perforation line (27), in some versions, the puncture can be formed as a slit (see FIG. 4) and/or a cut (see FIG. 5). In some other versions, the puncture can be formed as an opening, similar to opening (29) that may further expand during shrinking of shrink label (20).

To apply shrink label (20) to container (10), container (10) may be positioned within shrink label (20) in an open configuration, as shown in FIG. 3. For instance, shrink label (20) is configured as a sleeve having an opening (not shown) therethrough for receiving container (10). With container (10) positioned within shrink label (20), at least a portion of body (12) of container (10) is aligned with lower portion (22) of shrink label (20) and at least a portion of cap (16) is aligned with upper portion (24) of shrink label (20) to align trigger (18) with third perforation line (27). Heat can then be applied to shrink label (20) such that shrink label (20) forms to container (10), as shown in FIGS. 1 and 2. For instance, shrink label (20) can be heated to a temperature from about 90° C. to about 120° C. from about 6 seconds to about 8 seconds in a steam tunnel. It should be noted that the temperature and time for heating shrink label (20) can vary depending on the material selected for shrink label (20).

Accordingly, shrink label (20) is changeable from an expanded state (FIG. 3) towards a shrunk state (FIGS. 1 and 2) by applying energy, such as by any one or more of: UV-light, infra-red radiation, hot air, and steam. Alternatively or in addition to shrinking, shrink label (20) can be contracted by mechanical fastening (e.g. ties or bands). Alternatively or in addition, shrink label (20) can shrink by means of humidity change or by releasing elastic energy; for example, shrink label (20) as a stretch sleeve may be elastically expanded (expanded state) while being placed over a receptacle, after which the elastic tension is released (shrunk state). This can be done using techniques such as by an expandable and hollow transporting mandrel or by radially separable finger members. Accordingly, shrink label (20) may be a label such as any or more of: a stretch label, a shrink label, and a shrink sticker.

As shrink label (20) forms to container (10), third perforation line (27) tears and/or expands to form opening (29) to receive trigger (18), while upper portion (24) of shrink label (20) encloses nozzle (19). Trigger (18) of container (10) can thereby extend through opening (29). As best seen in FIG. 2, opening (29) includes a bottom surface (31) positioned below trigger (18), a top surface (35) positioned above trigger (18) and below nozzle (19), and a pair of opposing side surfaces (33) positioned outward of trigger (18). Shrink label (20) thereby maintains the position of cap (16) relative to body (12) to sufficiently secure cap (16) with body (12). This inhibits cap (16) from rotating and/or loosening relative to body (12) to inhibit product from leaking between cap (16) and body (12).

Opening (29) of shrink label (20) may also inhibit shrink label (20) from incidentally leaking product during the heat shrink process. For instance, if there were no opening (29) as shrink label (20) is applied to container (10), compressive forces from shrink label (20) may pivot trigger (18) to incidentally leak product from container (10). Opening (29) thereby allows trigger (18) to extend through opening (29) to inhibit shrink label (20) from pivoting trigger (18) and incidentally leaking product. Still other suitable methods for applying shrink label (20) to a container (10) will be apparent to one with ordinary skill in the art in view of the teachings herein. For instance, in some versions, third perforation line (27) may be formed after shrinking instead of prior to shrinking, such as by laser cutting.

While third perforation line (27) tears during shrinking, first and second perforation lines (26, 28) remain intact, as shown in FIGS. 1 and 2. Accordingly, to remove shrink label (20) from container (10), a user may pull downward on top surface (23) of shrink label (20) to break upper portion (24) along second perforation line (28) down to first perforation line (26). Upper portion (24) of shrink label (20) can then be ripped along first perforation line (26) to remove at least a portion of shrink label (20), such as upper portion (24), from container (10). At least a portion of cap (16) is thereby exposed to allow product to be dispensed from the container (10) by actuating trigger (18). Still other suitable configurations and methods for using shrink label (20) will be apparent to one with ordinary skill in the art in view of the teachings herein. For instance, in some versions, the entire shrink label (20) may be removed from container (10). In this version, first perforation line (26) may be omitted from shrink label (20) and second perforation line (28) may extend along all or a portion of the length of shrink label (20). Additionally or alternatively, shrink label (20) may comprise a pull-tab to aid in removing a portion of the shrink label (20).

In some versions, labels, product names, and/or other decorative features may be printed on an exterior surface of shrink label (20). In the illustrated version, opening (29) is configured to receive a trigger (18) of container (10). Additionally or alternatively, opening (29) can receive another portion of container (10) such as a handle and/or a nozzle-type opening. For instance, a handle can be grabbed by the user more easily when the handle is not covered or not completely covered by a shrink label (20) and/or a visual mark can be exposed.

Additionally or alternatively, shrink label (20) may be configured as a sleeve comprising pages for displaying e.g. a user manual, such as for medicines etc. The sleeve may show a decoration, such as text or a design. The sleeve may have a packaging function. The sleeve may be only locally shrunk, such as for tamper evidence applications. The sleeve may have a single layer or multilayer (e.g. coextruded) composition. The sleeve may be provided as a full label or as a partial label, i.e. one that covers only a portion of the container, such as a portion of an upper and/or a portion of a lower part of the container. The sleeve may have uniform thickness in a peripheral and/or a longitudinal direction.

### II. EXEMPLARY SHRINK LABEL COMPRISING A SLIT

FIG. 4 shows a second exemplary shrink label (120) that is similar to shrink label (20) described above, except that shrink label (120) comprises a puncture configured as a slit (127) in the open configuration prior to shrinking. Slit (127) is configured to expand during shrinking of shrink label (120) to form opening (29). In the illustrated version, slit (127) extends generally longitudinally along a portion of upper portion (24) transverse to first perforation line (26), though any other suitable orientations of slit (127) can be used such that slit (127) is configured to expand during shrinking of shrink label (20). In the illustrated version, slit (127) extends along only a portion of upper portion (24) such that slit (127) is positioned a first distance (d₁) above first perforation line (26) and a second distance (d₂) below a top surface (23) of shrink label (120). The length of slit (127) generally corresponds to the length of trigger (18), but any other suitable lengths can be used, such as a length corresponding to any suitable protrusion of container (10).

Accordingly, when shrink label (120) is heated, as discussed above, to form about container (10), slit (127) expands to form opening (29) (see FIGS. 1 and 2). Trigger (18) of container (10) can thereby extend through the opening formed by slit (127). This may allow shrink label (120) to inhibit incidental leaks through nozzle (19) that may be caused by shrink label (120) depressing trigger (18) during shrinking and/or relative movement between cap (16) and body (12) of container (10). Still other suitable configurations for shrink label (120) will be apparent to one with ordinary skill in the art in view of the teachings herein.

### III. EXEMPLARY SHRINK LABEL COMPRISING A CUT

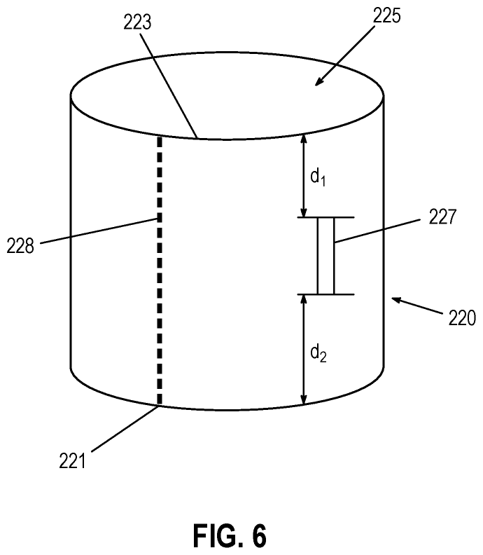

FIGS. 5 and 6 show a third exemplary shrink label (220), that is similar to shrink label (20) except that shrink label (220) comprises a puncture configured as a cut (227) in the open configuration prior to shrinking. As shown in FIG. 5, shrink label (220) is configured to be applied to a container (210) having a pump type of cap (216). Container (210) of the illustrated version comprises a body (212) and a cap (216) couplable with body (212). In the illustrated version, body (212) is in the form of a bottle, though any other suitable container can be used (e.g., a jug, a carton, a can, a jar, etc.). Body (212) defines an interior space for storing product. A top end portion of body (212) includes a neck (214) having an opening (not shown) to provide access to the product within body (212). Neck (214) is threadably coupled with cap (216) in the illustrated version. In some other versions, cap (216) may be coupled with body (212) using other suitable configurations, such as a snap fit, a friction fit, a living hinge, etc.

Cap (216) comprises a stationary portion (215) and a pump portion (217). Stationary portion (215) is couplable with neck (214) of container (210) and pump portion (217) is movable relative to stationary portion (215). Cap (216) further comprises a dispenser (219) that is fluidly connected with the interior space of body (212) of container (210). Accordingly, pump portion (217) may be actuated by depressing pump portion (217) towards stationary portion (215) to dispense product within body (212) through dispenser (219).

As shown in FIG. 5, shrink label (220) is applied to cap (216) such that an top surface (223) of shrink label (220) is positioned on a top portion of cap (216) on pump portion (217) and a bottom surface (221) of shrink label (220) is positioned on a bottom portion of cap (216) on stationary portion (215). Shrink label (220) is thereby configured to maintain the position of pump portion (217) relative to stationary portion (215) of cap (216) to inhibit pump portion (217) from being actuated. While shrink label (220) is shown as being applied to cap (216), in some other versions, shrink label (220) may extend downward onto at least a portion of body (212) of container (210).

Referring to FIGS. 5 and 6, shrink label (220) comprises a perforation line (228) extending substantially longitudinally along a length of shrink label (220) from bottom surface (221) to top surface (223) of shrink label (220). Shrink label (220) is breakable along perforation lines (228) such that perforation line (228) may help a user remove shrink label (220) from container (210). It should be noted that perforation line (228) is merely optional such that in some versions at least a portion of shrink label (220) can be removed from container (210) by merely tearing shrink label (220) without perforation line (228). While the illustrated version shows one perforation line (228) extending along the length of shrink label (220) to remove the entire shrink label (220) from container (210), in some other versions, perforation line (228) extends along only a portion of shrink label (220) and/or only a portion of shrink label (220) may be removed from container (210). Still other suitable configurations for perforation line (228) will be apparent to one with ordinary skill in the art in view of the teachings herein. For instance, any suitable number of perforation lines (228) can be used in any suitable orientation along shrink label (220) for removing shrink label (220) from container (210).

Referring to FIG. 5, shrink label (220) further comprises an opening (229) extending through shrink label (220) to allow dispenser (219) of container (210) to be exposed through opening (229) when shrink label (220) is applied to container (210). Prior to shrinking, as shown in FIG. 6, shrink label (220) comprises a puncture that is configured to tear and/or expand during shrinking of shrink label (220) to form opening (229). In the illustrated version, the puncture is configured as a cut (227) having a non-zero width extending generally longitudinally along a portion of shrink label (220), though any other suitable orientations for cut (227) can be used. Cut (227) can be formed by laser cutting to remove a portion of material of shrink label (220). Accordingly, cut (227) is configured to expand during shrinking of shrink label (220). As shown in FIG. 6, cut (227) extends along only a portion of shrink label (220) such that cut (227) is positioned a first distance (d₁) above bottom surface (221) and a second distance (d₂) below top surface (223) of shrink label (220). The length of cut (227) thereby generally corresponds to the diameter of dispenser (219), but any other suitable lengths can be used, such as a length corresponding to any suitable protrusion of container (210). Still other suitable configurations for cut (227) will be apparent to one with ordinary skill in the art in view of the teachings herein. For instance, in some versions, cut (227) and/or opening (229) may be formed after shrinking instead of prior to shrinking, such as by laser cutting.

To apply shrink label (220) to container (210), container (210) may be positioned within an opening (225) defined by shrink label (220) in an open configuration. For instance, at least a portion of cap (216) is aligned with shrink label (220) to align dispenser (219) with cut (227). Dispenser (219) can be inserted within cut (227) prior to or after heating. Heat can then be applied to shrink label (220), as described above, such that shrink label (220) forms to container (210), as shown in FIG. 5. As shrink label (220) forms to container (210), cut (227) expands to form opening (229) that is sufficiently sized to allow dispenser (219) to extend through opening (229). Shrink label (220) thereby maintains the position of pump portion (217) of cap (216) relative to stationary portion (215). This may inhibit incidental actuation of pump portion (217) to thereby inhibit incidental leaks of product from dispenser (219). In some versions, shrink label (220) extends about at least a portion of body (212) to maintain the position of cap (216) relative to body (212) to inhibit cap (216) from loosening relative to body (212).

To remove shrink label (220) from container (210), a user may pull downward on top surface (223) of shrink label (220) to tear shrink label (220) along perforation line (228). Shrink label (220) can then be removed from container (210). At least a portion of cap (216) is thereby be exposed to allow product to be dispensed from the container (210) by actuating pump portion (217). Still other suitable configurations and methods for using shrink label (220) will be apparent to one with ordinary skill in the art in view of the teachings herein. For instance, in some versions, only a portion of shrink label (220) may be removed such that another portion of shrink label (220) remains on body (212) and/or cap (216) of container (210).

### IV. EXEMPLARY APPARATUS AND METHOD OF MAKING A SHRINK LABEL

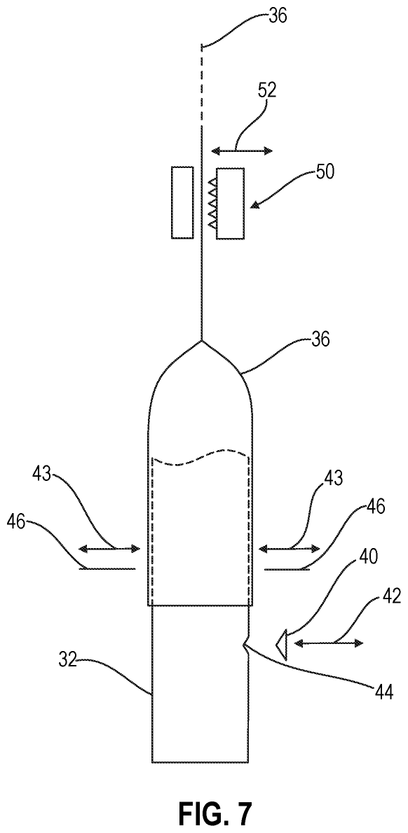

FIG. 7 shows an exemplary apparatus (30) for making a shrink label (20, 120, 220) that comprises a mandrel (32) configured to receive a continuous strip (36) of flexible tubular material. The term “tubular” is understood to mean at least having an inner and an outer periphery. The tubular material may be foil-like and/or film-like for forming shrink label (20, 120, 220). In some versions, the tubular material may comprise metal, such as a metal foil. Mandrel (32) is essentially columnar and has a generally vertical and stationary longitudinal axis. A top portion (not shown) of mandrel (32) has a spreading element that can convert a strip (36) of flexible tubular material from a flat form to an open form. The lower portion of mandrel (32) is shown in FIG. 7 and has a generally circular cross-sectional shape. In some versions, mandrel (32) can have any one or more of a circular, oval, polygonal and plate-like cross-sectional shape. Strip (36) can be introduced to mandrel (32) from a roll (not shown), which can be prepared in advance. The lower portion of mandrel (32) may be formed from a sleeve shot part of mandrel (32).

Apparatus (30) can include an advancing means (not shown) for feeding strip (36) through apparatus (30). The advancing means can comprise one or more first pairs of rollers that engage with the inner and outer surfaces of strip (36). In this way, strip (36) can be fed onto mandrel (32) from the mandrel's upper end. The advancing means can comprise one or more second pairs of rollers that engage with the inner and outer surfaces of strip (36) at a lower position on mandrel (32) than the first pair of rollers. In this way, a sleeve cut from strip (36) can be fed from the lower end of mandrel (32) to another production station. One or more of the rollers may be driven by an electric motor. One roller in each pair of rollers can be accommodated in recesses (not shown) provided in mandrel (32). In some versions, mandrel (32) is supported by some of the rollers.

As shown in FIG. 7, apparatus (30) comprises a blade (40), as a puncturing means, driven by a puncturing mechanism (not shown) for forming one or more of a puncture (e.g., a perforation line, a slit, a cut, etc.) of a predetermined length, within shrink label (20, 120, 220). For instance, the puncturing mechanism moves blade (40) toward and away from mandrel (32) in the radial directions, shown by the double-headed arrow (42). In the illustrated version, the movement is linear, but in other versions, the movement may comprise any or more of a linear, circular, and/or elliptical motion. For instance, blade (40) may rotate about an axis such that blade (40) may be a rotating (spinning) blade whose cutting profile is eccentric to its axis of rotation. The motion of blade (40) may be driven any one or more of: electrically, pneumatically, and hydraulically. For instance, blade (40) may be driven by an electric motor such as a servomotor and/or a reciprocating pneumatic actuator. Blade (40) punctures the wall-thickness of shrink label (20, 120, 220) from one (outer) side while mandrel (32) (opening device) supports strip (36) from the other (inner) side. Blade (40) in the illustrated version has a triangular shaped profile. The blade profile may alternatively comprise a plurality of triangular shapes arranged in a generally vertical line. The leading vertex of the triangular shape may have an angle of about 45 degrees. By providing more than one triangular shape, such as a saw-tooth like profile, the required stroke of blade (40) for a given puncture length can be kept short.

Mandrel (32) comprises a recess (44) on its surface for receiving blade (40). Blade (40) can enter recess (44), which is shaped in correspondence with the triangular profile of blade (40) in the illustrated version. In other versions, recess (44) may have other shapes, such as a straight and/or circular, and/or recess (44) may be a through-hole. Recess (44) may extend in a peripheral direction at least partly around mandrel (32). Recess (44) may be configured so that the puncturing means (40) does not contact mandrel (32). Apparatus (30) further comprises a rotary cutter (46), as a cutting means, comprising one or more blades that can move toward and away from mandrel (32) in the radial directions shown by the double-headed arrow (43) so as to cut strip (36) peripherally, above blade (40). Rotary cutter (46) is configured to make the peripheral cut about strip (36). In some other versions, cutter (46) may be provided as a different type of cutter such as a flat cutter. The advancing means, blade (40), and/or rotary cutter (46) can be configured to cooperate with timed fashion by means of a control unit (not shown).

Apparatus (30) optionally includes a perforation means (50) for making perforation lines (26, 28, 228). The perforation means (50) can comprise a respective perforating blade or blades for each perforation line and/or it can comprise a common perforating blade. The perforation means (50) is configured to reciprocatingly puncture a portion or portions of strip (36) upstream of mandrel (32), the directions of reciprocation being shown by the double-headed arrow (52). The perforation means (50) is thus configured to puncture a flattened portion of the strip (36). In some versions, the perforation means (50) may be provided downstream of mandrel (32).

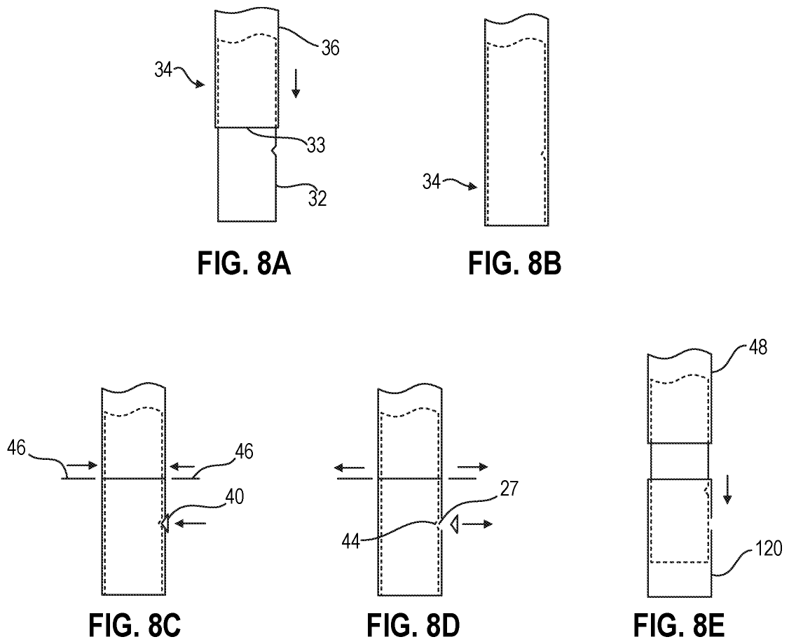

FIGS. 8A to 8E show a method of making shrink label (120) with apparatus (30). While apparatus (30) is shown as forming shrink label (120), apparatus (30) can be configured to form shrink labels (20, 220) as is discussed below and will be apparent to one with ordinary skill in the art in view of the teachings herein. As shown in FIG. 8A, a strip (36) of tubular material is fed onto mandrel (32) from the top portion of mandrel (32), for example by means of the first roller pairs of the advancing means. Strip (36) is fed until a free end (33) of a free-end portion (34) of strip (36) reaches a predetermined position along mandrel (32), such as the bottom end of mandrel (32) (FIG. 8B). Thus, a region of the strip becomes an open region held open and/or supported by mandrel (32). At this point the feeding is stopped.

When strip (36) is fed onto mandrel (32), the tubular material of strip (36) is opened from a flattened configuration to an open or tubular configuration, which may be performed by an opening device executed as a mandrel (32) or in addition to a mandrel (32). The opening device may comprise a guide such as a plate-like guide, a guide of varying cross-section, or any a structural member that supports the inside of strip (36). Alternatively or in addition, the opening device may comprise a tunnel or passageway aligned in a feeding direction and having one or more porous inner surfaces connected to a vacuum; the wall of strip (36) is thus pulled apart by low air pressure as strip (36) is received by the opening device; the porous surfaces may be stationary or conveyable; even here the opening portion is formed by moving apart inner peripheral portions of strip (36). At least part of the open portion of strip (36) may be spaced from the opening device. Alternatively or in addition, strip (36) may be inflated with internal pressure.

Subsequently a puncturing step is performed, as shown in FIG. 8C, wherein blade (40) penetrates strip (36) and enters recess (44) to form one or more punctures in a region of strip (36). The puncture may include one or more of a perforation line (27), a slit (127), a cut (227) and/or other suitable puncture that is configured to tear and/or expand during shrinking of shrink label (20, 120, 220). The puncture can be formed by removing a portion of the tubular material, or by partially removing the portion so as to leave a flap of material. The puncture may have a predefined (e.g. non-zero) width. Strip (36) is punctured at a first distance from its free end (33) such that longitudinal end portions of the sleeve are not punctured in making the puncture and the puncture is surrounded on all its sides by unpunctured material. For instance, FIG. 8C depicts blade (40) as a slitting blade having a generally triangular shaped profile to puncture a generally longitudinal slit (127) within strip (36). In some other versions, the puncturing means may comprise a punch having a circular, elliptical, or polygonal (e.g. square or rectangular) section. The extents of the slit (127) may be formed in correspondence with the extents of blade (40). In other words, a longitudinally upper extent of the slit (127) may be formed by (or in correspondence with) the longitudinally upper extent of blade (40), and a longitudinally lower extent of the slit (127) may be formed by (or in correspondence with) the longitudinally lower extent of blade (40). In some versions, apparatus (30) is adapted to make a perforation line (27) by replacing the slitting blade described above with a perforating blade having a plurality of triangular shaped blades. In some other versions, apparatus (30) is adapted to make a cut (227) by replacing slitting blade described above with a laser cutter. Accordingly, the puncturing means can comprise a slitting blade, a perforation blade, and/or a laser cutter, extending along the mandrel axis.

Because the puncturing is performed on a portion of the strip (36), and the portion is provided on the mandrel (32), accuracy and repeatability are improved. Also, blade (40) is prevented from puncturing the wall of strip (36) twice, as would be the case if strip (36) were punctured in a flattened state. Puncturing is performed by moving blade (40) in a plane generally parallel to the axis of mandrel (32). Accordingly, accuracy and repeatability of the puncturing can be further improved.

Strip (36) is further cut about its periphery, optionally during the puncturing step shown in FIG. 8C. For instance, rotary cutter (46) can be configured to start and optionally complete the cutting before the puncturing. It may also be provided that cutter (46) peripherally cuts a part of the tubular material that is not on mandrel (32), such as upstream or downstream of mandrel (32). Strip (36) is cut at a second distance from its free end (33), the second distance being greater than the first distance. After cutting, rotary cutter (46) is retracted. After puncturing, blade (40) is retracted (see FIG. 8D). The end portion of the strip (36) forms the end portion of shrink label (20, 120, 220). The free end (33) becomes an open end of shrink label (20, 120, 220).

In the illustrated version, the puncturing means is provided below cutter (46) at mandrel (32). In some other versions, the puncturing means may be provided in other locations, such as above cutter (46), or at any place where the flexible tubular material is open (e.g. unflattenned). The method may be adapted accordingly, for example: after the puncturing, the tubular material may be fed, until the portion of the tubular material corresponding to a shrink label end coincides with cutter (46). The cutting may then be performed. Accordingly, the cutting may simultaneously create a top surface (23, 223) of shrink label (23, 120, 220) and a bottom surface (21, 221) of a next shrink label (20, 120, 220). The tubular material which will become the next shrink label (20, 120, 220) may be punctured during said cutting. Cutting need not be performed if for example the length of strip (36) is the length of shrink label (20, 120, 220). Mandrel (32) may be stationary (e.g. rotationally stationary) during the puncturing and/or cutting. Strip (36) may be stationary relative to mandrel (32) during the puncturing such as at least rotationally stationary. Alternatively or in addition, at least part of the puncturing may coincide with at least part of the feeding.

Subsequently, shrink label (20, 120, 220) is advanced (FIG. 8E) in the direction of the solid arrow of FIG. 8E by means of the second pairs of rollers so that it leaves mandrel (32) from the mandrel's bottom end. The advancing means may transfer the newly-made free-end portion (48) of strip (36) to the predetermined position at the same time that, or shortly after, shrink label (20, 120, 220) is transferred from mandrel (32). In some versions, shrink label (20, 120, 220) is transferred from mandrel (32) to a receptacle (not shown in FIG. 8A to 8E), positioned under mandrel (32). Still other suitable configurations and methods for operating apparatus (30) will be apparent to one with ordinary skill in the art in view of the teachings herein.

For instance, shrink labels (20, 120, 220) can be formed by sequentially cutting strip (36) at predetermined intervals. Furthermore, a linear series of containers (10) can be arranged, each container (10) being sequentially conveyed to a common position for receiving a shrink label (20, 120, 220). Each container (10) with a shrink label (20, 120, 220) can be conveyed to a processing station (not shown) for shrinking, such as a heater for heat-shrinking. In this way, a container assembly is made by performing the method to make a shrink label (20, 120, 220) followed by using shrink label (20, 120, 220) to cover at least a portion of container (10). Still other suitable methods for making shrink label (20, 120, 220) will be apparent to one with ordinary skill in the art in view of the teachings herein.

### V. EXAMPLES

The following examples relate to various non-exhaustive ways in which the teachings herein may be combined or applied. It should be understood that the following examples are not intended to restrict the coverage of any claims that may be presented at any time in this application or in subsequent filings of this application. No disclaimer is intended. The following examples are being provided for nothing more than merely illustrative purposes. It is contemplated that the various teachings herein may be arranged and applied in numerous other ways. It is also contemplated that some variations may omit certain features referred to in the below examples. Therefore, none of the aspects or features referred to below should be deemed critical unless otherwise explicitly indicated as such at a later date by the inventors or by a successor in interest to the inventors. If any claims are presented in this application or in subsequent filings related to this application that include additional features beyond those referred to below, those additional features shall not be presumed to have been added for any reason relating to patentability.

### Example 1

A shrink label comprising: a tubular material having a first end surface and a second end surface; and a puncture extending along a portion of the tubular material between the first and second end surfaces such that the puncture is spaced a first distance away from the first end surface and the puncture is spaced a second distance away from the second end surface; wherein the shrink label is configured to shrink from an open state to a shrunk state; wherein the puncture is expandable to form an opening when the shrink label shrinks from the open state to the shrunk state.

### Example 2

The shrink label of example 1, wherein the puncture comprises one or more of a perforation line, a slit, a cut, and an opening.

### Example 3

The shrink label of any one or more of examples 1 through 2, wherein the puncture is positioned generally longitudinally along the shrink label.

### Example 4

The shrink label of any one or more of examples 1 through 3, wherein the shrink label comprises a longitudinal perforation line extending longitudinally along at least a portion of the shrink label, wherein the perforation line is configured to remain intact when the shrink label shrinks from the open state to the shrunk state, wherein the perforation line is configured to tear to separate at least a portion of the shrink label from another portion of the shrink label after the shrink label is in the shrunk state.

### Example 5

The shrink label of any one or more of examples 1 through 4, wherein the shrink label comprises a circumferential perforation line extending circumferentially about at least a portion of the shrink label, wherein the perforation line is configured to remain intact when the shrink label shrinks from the open state to the shrunk state, wherein the perforation line is configured to tear to separate at least a portion of the shrink label from another portion of the shrink label after the shrink label is in the shrunk state.

### Example 6

The shrink label of example 5, wherein the puncture is spaced a distance away from the circumferential perforation line.

### Example 7

The shrink label of any one or more of examples 1 through 6, wherein the shrink label is applied to a container in the shrunk state, wherein the container comprises a protrusion, wherein the opening formed by the puncture is sufficiently sized to receive the protrusion of the container therethrough.

### Example 8

The shrink label of example 7, wherein the container comprises a trigger, wherein the opening formed by the puncture is configured to receive the trigger therethrough to inhibit actuation of the trigger.

### Example 9

The shrink label of example 7, wherein the container comprises a dispenser, wherein the opening formed by the puncture is configured to receive the dispenser therethrough to inhibit actuation of the dispenser.

### Example 10

The shrink label of any one or more of examples 1 through 9, wherein the shrink label is applied to a container in the shrunk state, wherein the container comprises a cap having a stationary portion and a pump portion movable relative to the stationary portion, wherein the shrink label is applied to the cap of the container to maintain the position of the pump portion relative to the stationary portion.

### Example 11

The shrink label of any one or more of examples 1 through 10, wherein the shrink label is applied to a container in the shrunk state, wherein the container comprises a body and a cap coupled with the body, wherein the shrink label is applied to at least a portion of the body and at least a portion of the cap to maintain the position of the cap relative to the body.

### Example 12

The shrink label of any one or more of examples 1 through 11, wherein the shrink label is applied to a container in the shrunk state, wherein at least a portion of the shrink label is removable from the container prior to use of the container.

### Example 13

A method of applying a shrink label to a container, wherein the shrink label comprises a first end surface, a second end surface, and a puncture extending along a portion of the shrink label between the first and second end surfaces such that the puncture is spaced a first distance away from the first end surface and the puncture is spaced a second distance away from the second end surface, the method comprising the steps of: positioning the shrink label about at least a portion of the container to align the puncture of the shrink label with a protrusion of the container; and shrinking the shrink label from an open state to a shrunk state to form the shrink label to the container; wherein the puncture expands to form an opening when the shrink label shrinks from the open state to the shrunk state such that the opening receives the protrusion of the container therethrough when the shrink label shrinks from the open state to the shrunk state.

### Example 14

The method of example 13, further comprising removing at least a portion of the shrink label from the container.

### Example 15

The method of example 14, wherein the shrink label comprises a perforation line, wherein the shrink label is torn along the perforation line when the at least a portion of the shrink label is removed from the container.

Having shown and described various embodiments of the present invention, further adaptations of the methods and systems described herein may be accomplished by appropriate modifications by one of ordinary skill in the art without departing from the scope of the present invention. Several of such potential modifications have been mentioned, and others will be apparent to those skilled in the art. For instance, the examples, embodiments, geometrics, materials, dimensions, ratios, steps, and the like discussed above are illustrative and are not required. Accordingly, the scope of the present invention should be considered in terms of any claims that may be presented and is understood not to be limited to the details of structure and operation shown and described in the specification and drawings.

1. A shrink label comprising:
a tubular material having a first end surface and a second end surface; and
a puncture extending along a portion of the tubular material between the first and second end surfaces such that the puncture is spaced a first distance away from the first end surface and the puncture is spaced a second distance away from the second end surface;
wherein the shrink label is configured to shrink from an open state to a shrunk state;
wherein the puncture is expandable to form an opening when the shrink label shrinks from the open state to the shrunk state.

2. The shrink label of claim 1, wherein the puncture comprises one or more of a perforation line, a slit, a cut, and an opening.

3. The shrink label of claim 1, wherein the puncture is positioned generally longitudinally along the shrink label.

4. The shrink label of claim 1, wherein the shrink label comprises a longitudinal perforation line extending longitudinally along at least a portion of the shrink label, wherein the perforation line is configured to remain intact when the shrink label shrinks from the open state to the shrunk state, wherein the perforation line is configured to tear to separate at least a portion of the shrink label from another portion of the shrink label after the shrink label is in the shrunk state.

5. The shrink label of claim 1, wherein the shrink label comprises a circumferential perforation line extending circumferentially about at least a portion of the shrink label, wherein the perforation line is configured to remain intact when the shrink label shrinks from the open state to the shrunk state, wherein the perforation line is configured to tear to separate at least a portion of the shrink label from another portion of the shrink label after the shrink label is in the shrunk state.

6. The shrink label of claim 5, wherein the puncture is spaced a distance away from the circumferential perforation line.

7. The shrink label of claim 1, wherein the shrink label is applied to a container in the shrunk state, wherein the container comprises a protrusion, wherein the opening formed by the puncture is sufficiently sized to receive the protrusion of the container therethrough.

8. The shrink label of claim 7, wherein the container comprises a trigger, wherein the opening formed by the puncture is configured to receive the trigger therethrough to inhibit actuation of the trigger.

9. The shrink label of claim 7, wherein the container comprises a dispenser, wherein the opening formed by the puncture is configured to receive the dispenser therethrough to inhibit actuation of the dispenser.

10. The shrink label of claim 1, wherein the shrink label is applied to a container in the shrunk state, wherein the container comprises a cap having a stationary portion and a pump portion movable relative to the stationary portion, wherein the shrink label is applied to the cap of the container to maintain the position of the pump portion relative to the stationary portion.

11. The shrink label of claim 1, wherein the shrink label is applied to a container in the shrunk state, wherein the container comprises a body and a cap coupled with the body, wherein the shrink label is applied to at least a portion of the body and at least a portion of the cap to maintain the position of the cap relative to the body.

12. The shrink label of claim 1, wherein the shrink label is applied to a container in the shrunk state, wherein at least a portion of the shrink label is removable from the container prior to use of the container.

13. A method of applying a shrink label to a container, wherein the shrink label comprises a first end surface, a second end surface, and a puncture extending along a portion of the shrink label between the first and second end surfaces such that the puncture is spaced a first distance away from the first end surface and the puncture is spaced a second distance away from the second end surface, the method comprising the steps of:
positioning the shrink label about at least a portion of the container to align the puncture of the shrink label with a protrusion of the container; and
shrinking the shrink label from an open state to a shrunk state to form the shrink label to the container;
wherein the puncture expands to form an opening when the shrink label shrinks from the open state to the shrunk state such that the opening receives the protrusion of the container therethrough when the shrink label shrinks from the open state to the shrunk state.

14. The method of claim 13, further comprising removing at least a portion of the shrink label from the container.

15. The method of claim 14, wherein the shrink label comprises a perforation line, wherein the shrink label is torn along the perforation line when the at least a portion of the shrink label is removed from the container.
